(19) United States
(12) Patent Application Publication
(10) Pub. No.: US 2006/0164971 A1
(43) Pub. Date: Jul. 27, 2006

(54) Pilot symbol transmission for multiple-transmit communication system

(75) Inventors: Rajendra T. Moorti, Mountain View, CA (US); Rohit Gaikwad, San Diego, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 11/188,803

(22) Filed: Jul. 26, 2005

Related U.S. Application Data
(60) Provisional application No. 60/591,096, filed on Jul. 27, 2004.
(60) Provisional application No. 60/634,101, filed on Dec. 8, 2004.

(51) Int. Cl. H04J 11/00

(52) U.S. Cl. 370/208; 370/338

(57) ABSTRACT

A network device for transmitting a set of known pilot symbols in a communications system utilizing a plurality of transmit sources. The network device includes generating means for generating the set of known pilot symbols to be transmitted for each of the plurality of transmit sources and inserting means for inserting pilot symbols for each of the plurality of transmit sources. The network device also includes creating means for creating a near to full orthogonal matrix over time and frequency using the fewest number of pilot symbols. The pilot symbols are used for at least one of channel, frequency, and phase tracking at a receiving station.

This application claims benefit under 35 U.S.C §119(e) of provisional application No. 60/591,096, filed on Jul. 27, 2004, and U.S. provisional application No. 60/634,101 filed Dec. 8, 2004, the contents of which is hereby incorporated by reference.

### BACKGROUND OF THE INVENTION

1. Field of the Invention

This invention relates to identification of transmission sources and coherent detection in multiple-transmit communication systems.

2. Description of the Related Art

Wireless communications systems enable various types of communications. One type of wireless communication between a single transmitter and a single receiver is known as a single-output-single-input (SISO) communication. The transmitter includes one antenna for transmitting radiofrequency (RF) signals, which are received by one or more antennas of the receiver. When the receiver includes two or more antennas, the receiver selects one of antennas to receive the incoming RF signals. Another type of wireless communication is a multiple-input-multiple-output (MIMO) communication. In a MIMO wireless communication, the transmitter and the receiver each includes multiple paths. In such a communication, the transmitter parallel processes data using a spatial and time encoding function to produce two or more streams of data. The transmitter includes multiple transmission paths to convert each stream of data into multiple RF signals. The receiver receives the multiple RF signals via multiple receiver paths that recapture the streams of data utilizing a spatial and time decoding function. The recaptured streams of data are combined and subsequently processed to recover the original data.

Different wireless devices in a wireless communication system may be compliant with different standards or different variations of the same standard. For example, IEEE™ 802.11a, an extension of the IEEE™ 802.11 standard, provides up to 54 Mbps in the 5 GHz band. IEEE™ 802.11g, another extension of the 802.11 standard, provides 20+Mbps in the 2.4 GHz band. Devices implementing both the 802.11a and 802.11g standards use an orthogonal frequency division multiplexing (OFDM) encoding scheme. OFDM is a frequency division multiplexing modulation technique for transmitting large amounts of digital data over a radio wave. OFDM works by spreading a single data stream over a band of sub-carriers, each of which is transmitted in parallel. In 802.11a and 802.11g compliant devices as defined in the IEEE™ standards, only 52 of the 64 active sub-carriers are used. Four of the active sub-carriers are pilot sub-carriers which include known pilot symbols that allow for channel, frequency and/or phase tracking at a receiving station. The remaining 48 sub-carriers provide separate wireless pathways for sending information in a parallel fashion.

Current pilot transmissions apply to single transmit chains. In order for the pilot signals to be useful across a variety of channel realizations, the same pilot signals should not be used on all transmit paths. Therefore, there exists a need for pilot symbols to be transmitted across multiple transmit sources or multiple transmitters.

### SUMMARY OF THE INVENTION

According to one aspect of the invention, there is provided a network device for transmitting a set of known pilot symbols in a communications system. The network device includes generating means for generating the set of known pilot symbols to be transmitted for each of a plurality of transmit sources and inserting means for inserting pilot symbols into sub-carriers for each of the plurality of transmit sources. The network device also includes creating means for creating a near to full orthogonal matrix over time and frequency using a minimum number of pilot symbols. The pilot symbols are used for at least one of channel, frequency, and phase tracking at a receiving station.

According to another aspect of the invention, there is provided a method for transmitting a set of known pilot symbols in a communications system. The method includes the steps of generating the set of known pilot symbols to be transmitted for each of the plurality of transmit sources and inserting pilot symbols for each of the plurality of transmit sources. The method also includes the steps of creating a near to full orthogonal matrix over time and frequency using a minimum number of pilot symbols and using the pilot symbols for at least one of channel, frequency, and phase tracking at a receiving station.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention, wherein:

FIG. 1 illustrates a communication system that includes a plurality of base stations, a plurality of wireless communication devices and a network hardware component;

FIG. 2a illustrates an example of a two transmitter pilot specification for situations where there are two transmitters and when two pilots are to be sent per transmitter;

FIG. 2b illustrates an example of a three transmitter pilot specification for situations where there are three transmitters and when two pilots are to be sent per transmitter;

FIG. 2c illustrates an example of a four transmitter pilot specification for situations where there are four transmitters and when two pilots are to be sent per transmitter;

FIG. 3a illustrates the case when four pilots are to be transmitted for one transmitter;

FIG. 3b illustrates the case when four pilots are to be transmitted for two transmitters;

FIG. 3c illustrates the case when four pilots are to be transmitted for three transmitters;

FIG. 3d illustrates the case when four pilots are to be transmitted for four transmitters;

FIG. 4a illustrates the case when eight pilots are to be transmitted for one transmitter;

FIG. 4b illustrates the case when eight pilots are to be transmitted for two transmitters;

FIG. 4c illustrates the case when eight pilots are to be transmitted for three transmitters;

FIG. 4d illustrates the case when eight pilots are to be transmitted for four transmitters;

FIG. 5a illustrates an example of a matrix where the pilot sets are swapped every symbol for two transmitters to maintain robustness;

FIG. 5b illustrates an example of a matrix where the pilot sets are swapped every pair symbols for three transmitters to maintain robustness; and

FIG. 5c illustrates an example of a matrix where the pilot sets are swapped every pair symbols for four transmitters to maintain robustness.

### DETAILED DESCRIPTION OF THE PREFERRED EMBODIMENTS

Reference will now be made to the preferred embodiments of the present invention, examples of which are illustrated in the accompanying drawings.

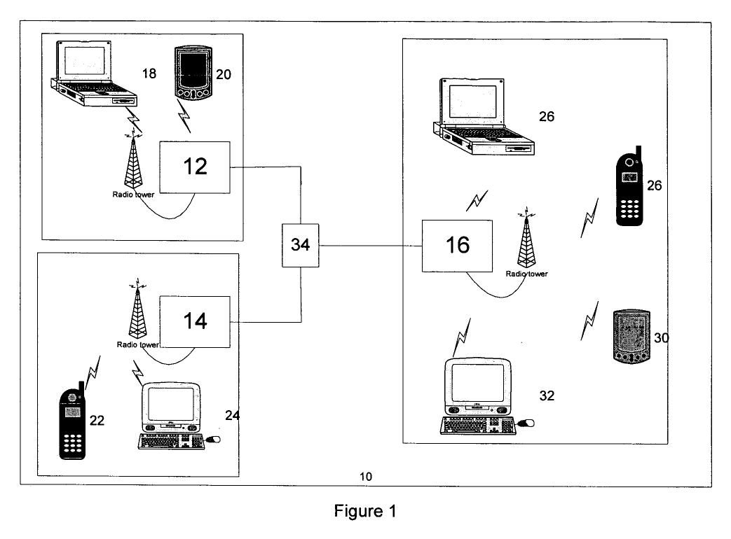

FIG. 1 illustrates a communication system 10 that includes a plurality of base stations and/or access points 12-16, a plurality of wireless communication devices 18-32 and a network hardware component 34. Wireless communication devices 18-32 may be laptop computers 18 and 26, personal digital assistant hosts 20 and 30, personal computer 24 and 32 and/or cellular telephone 22 and 28. Base stations or access points 12-16 are operably coupled to network hardware 34 via local area network connections 36, 38 and 40. Network hardware 34, for example a router, a switch, a bridge, a modem, or a system controller, provides a wide area network connection for communication system 10. Each of base stations or access points 12-16 has an associated antenna or antenna array to communicate with the wireless communication devices in its area. Typically, the wireless communication devices register with a particular base station or access point 12-14 to receive services from communication system 10. Each wireless communication device includes a built-in radio or is coupled to an associated radio. The radio includes at least one radio frequency (RF) transmitter and at least one RF receiver.

Each wireless communication device participating in wireless communications includes a built-in radio transceiver (i.e., receiver and transmitter) or is coupled to an associated radio transceiver. As is known to those skilled in the art, the transmitter typically includes a data modulation stage, one or more intermediate frequency stages, and a power amplifier. The data modulation stage converts raw data into baseband signals in accordance with a particular wireless communication standard. The intermediate frequency stages mix the baseband signals with one or more local oscillations to produce RF signals. The power amplifier amplifies the RF signals prior to transmission via an antenna.

The receiver is typically coupled to the antenna and includes a low noise amplifier, one or more intermediate frequency stages, a filtering stage, and a data recovery stage. The low noise amplifier receives, via the antenna, inbound RF signals and amplifies the inbound RF signals. The intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with a particular wireless communication standard.

According to an embodiment of the invention, a set of known pilot symbols are used to identify multiple transmit sources. The known pilot signals/symbols or multiples of known signals can be inserted into a data stream. As such, the invention is related to pilot symbol transmissions for communication systems utilizing multiple transmit sources or multiple transmitters and to a method of utilizing known pilot symbols to identify multiple transmit sources. The pilot symbols are used for multiple transmit stream communications and allow for channel, frequency and/or phase tracking at a receiving station. Therefore, pilots in one embodiment of the invention are selected to provide good performance across different types of channels.

An embodiment of the present invention creates near-to-full orthogonal matrices over time and frequency. The invention also allows for correction of uncorrelated phase noise across transmitters and symbols. As shown below, when there are fewer pilots than transmitters, the pilots can be sent in subsets over time. Embodiments of the invention utilize the insertion of weighted pilot symbols for situations where there are various transmitters. For example, signals can have polarities inverted with respect to varying transmitters, or other configurations, to properly identify the source of a particular signal.

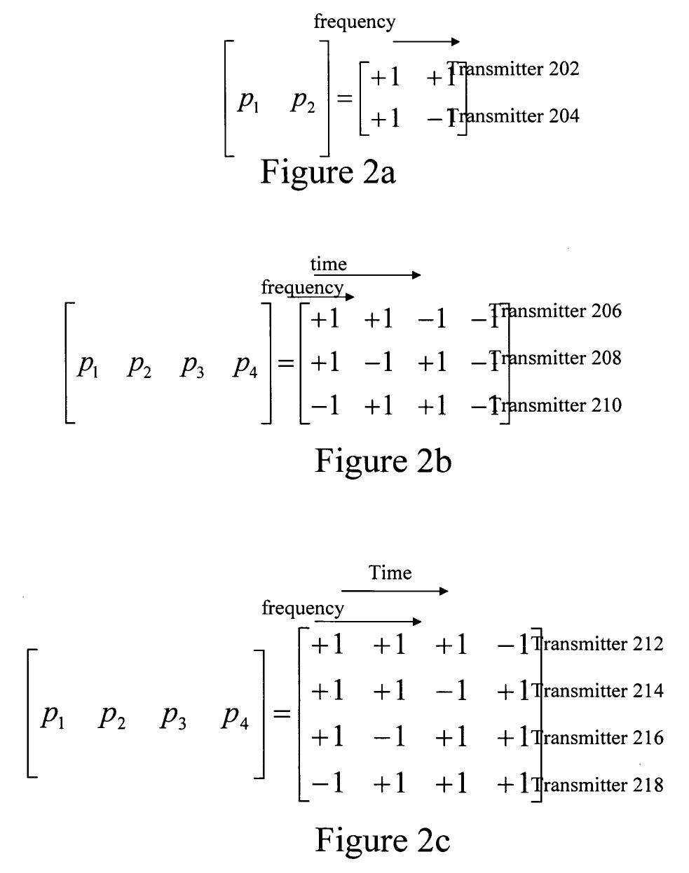

In the situation of a two transmitter pilot specification when two pilots are to be sent per transmitter, when n=1, 2, etc, for symbols 2n-1, transmitters 1-2 send the values in vector p₁, as shown in FIG. 2a, on pilot #1 in sub-carrier #-21 and in vector p₂ on pilot #2 in sub-carrier #21. Where n=1, 2, etc, for symbols 2n, transmitters 1-2 send the values in vector p₂ on pilot #1 in sub-carrier #−21 and in vector p₁ on pilot #2 in sub-carrier #21. According to this embodiment, the phase noise correction bandwidth for two transmitters remains at 1/T_{sym}. Phase error can be uncorrelated from symbol to symbol. FIG. 2a illustrates an example of a two transmitter pilot specification for situations where there are two transmitters 202-204 and when two pilots are to be sent per transmitter. As shown in FIG. 2a, transmitter 202 transmits the values [+1+1] in one symbol in one time period and transmitter 204 transmits the values [+1−1] in one symbol in one time period.

In the situation of a three transmitter pilot specification when two pilots are to be sent per transmitter, when n=1, 2, etc, for symbols 2n-1, transmitters 1-3 send the values in vector p₁, as shown in FIG. 2c, on pilot #1 in sub-carrier #−21, if n is odd; in vector p₂ on pilot #1 in sub-carrier #−21, if n is even; in vector p₂ on pilot #2 in sub-carrier #+21, if n is odd and in vector p₁ on pilot #2 in sub-carrier #+2 1, if n is even. Where n=1, 2, etc, for symbols 2n, transmitters 1-3 send the values in vector p₃, as shown in FIG. 2b, on pilot #1 in sub-carrier #−2 1, if n is odd; in vector p₄ on pilot #1 in sub-carrier #−2 1, if n is even; in vector p₄ on pilot #2 in sub-carrier #+21, if n is odd and in vector p₃ on pilot #2 in sub-carrier #+21, if n is even. FIG. 2b illustrates an example of a three transmitter pilot specification for situations where there are three transmitters 206-210 and when two pilots are to be sent per transmitter in each time period. As shown in FIG. 2b, transmitter 206 transmits the values [+1+1] in a first symbol in a first time period and the values [−1−1] in a second symbol in a second time period. Similarly, transmitter 208 transmits the values [+1−1] in the first symbol in the first time period and the values [+1−1] in the second symbol in the second time period. Transmitter 210 transmits the values [−1+1] in the first symbol in the first time period and the values [+1−1] in the second symbol in a second time period.

In the situation of a four transmitter pilot specification when two pilots are to be sent per transmitter, when n=1, 2, etc, for symbols 2n-1, transmitters 1-4 send the values in vector p₁, as shown in FIG. 2c, on pilot #1 in sub-carrier #−21, if n is odd; in vector p₂ on pilot #1 in sub-carrier #−21, if n is even; in vector p₂ on pilot #2 in sub-carrier #+2 1, if n is odd; and in vector p₁ on pilot #2 in sub-carrier #+21, if n is even. Where n=1, 2, etc, for symbols 2n, transmitters 1-4 send the values in vector p₃ on pilot #1 in sub-carrier #−21, if n is odd; in vector p₄ on pilot #1 in sub-carrier #−2 1, if n is even; in vector p₄ on pilot #2 in sub-carrier #+2 1, if n is odd and in vector p₃ on pilot #2 in sub-carrier #+21, if n is even. FIG. 2c illustrates an example of a four transmitter pilot specification for situations where there are four transmitters 212-218 and when two pilots are to be sent per transmitter. As shown in FIG. 2c, transmitter 212 transmits the values [+1+1] in a first symbol in a first time period and the values [+1−1] in a second symbol in a second time period. Similarly, transmitter 214 transmits the values [+1+1] in the first symbol in the first time period and the values [−1+1] in the second symbol in the second time period. Transmitter 216 transmits the values [+1−1] in the first symbol in the first time period and the values [+1+1] in the second symbol in a second time period. Transmitter 218 transmits the values [−1+1] in the first symbol in the first time period and the values [+1+1] in the second symbol in a second time period.

According to the embodiments in FIGS. 2b and 2c, phase noise correction bandwidth for three and four transmitters is reduced only to ½ T_{sym}.

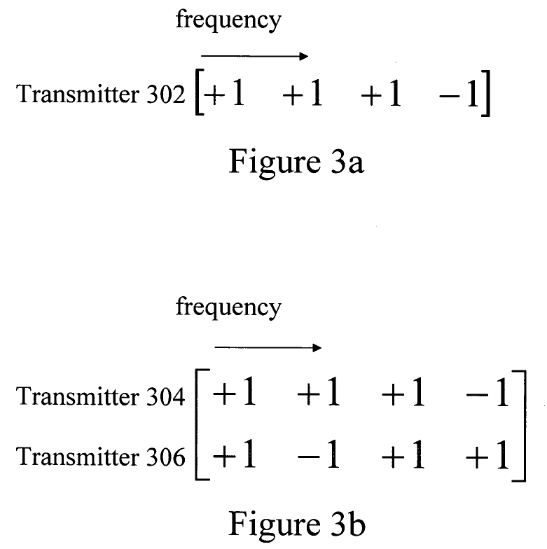

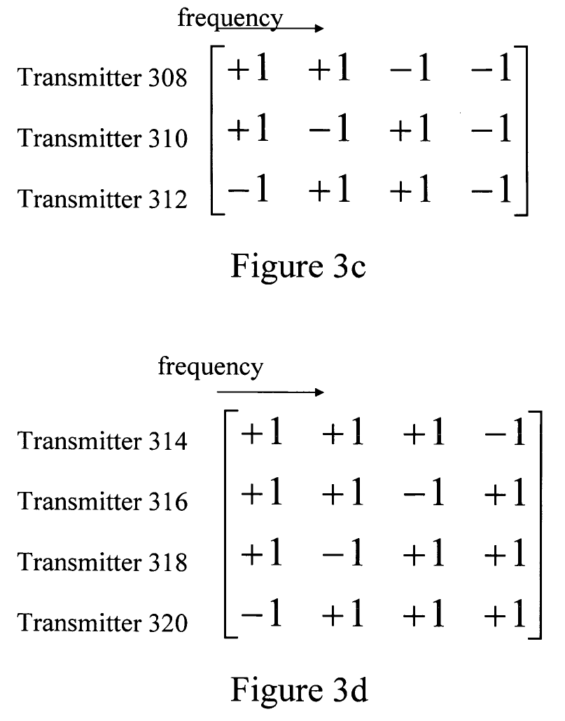

According to one embodiment of the invention, up to four pilots may be transmitted per antenna. FIG. 3a illustrates the case when four pilots are to be transmitted for one transmitter 302. FIG. 3b illustrates the case when four pilots are to be transmitted for two transmitters 304-306. FIG. 3c illustrates the case when four pilots are to be transmitted for three transmitters 308-312. FIG. 3d illustrates the case when four pilots are to be transmitted for four transmitters 314-320. According to FIGS. 3a and 3d, the pilot sets from each of transmitters 302-320 are transmitted in one symbol over one time period. As such, the matrices of FIGS. 3a-3d are for a single symbol. Furthermore, as illustrated in FIGS. 3a and 3d, the columns of the matrices may be cycled over symbols for robustness across various channels.

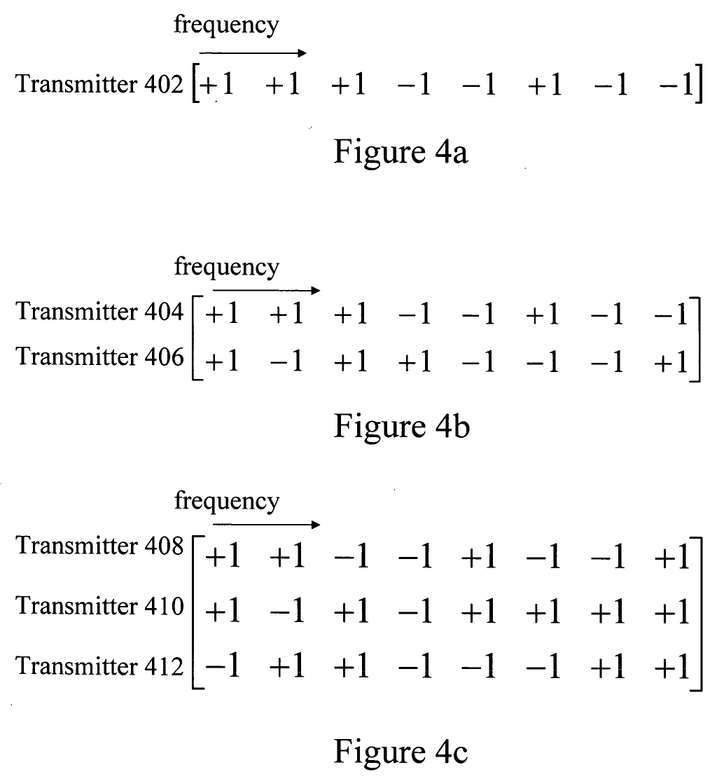

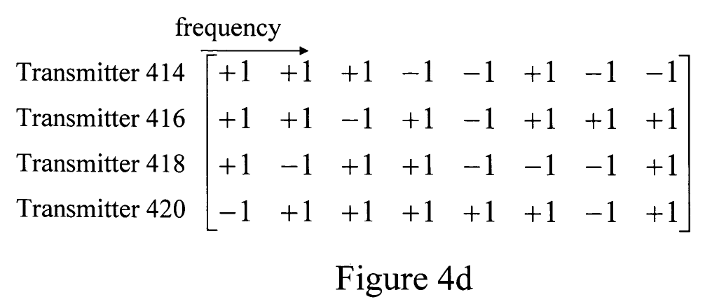

According to one embodiment of the invention, up to eight pilots may be transmitted per antenna. FIG. 4a illustrates the case when eight pilots are to be transmitted for one transmitter 402. FIG. 4b illustrates the case when eight pilots are to be transmitted for two transmitters 404-406. FIG. 4c illustrates the case when eight pilots are to be transmitted for three transmitters 408-412. FIG. 4d illustrates the case when eight pilots are to be transmitted for four transmitters 414-420. According to FIGS. 4a and 4d, the pilot sets from each of transmitters 402-420 are transmitted in one symbol over one time period. As such, the matrices of FIGS. 4a-4d are for a single symbol. Furthermore, as illustrated in FIG. 4a-4d, the columns of the matrices may be cycled over symbols for robustness across various channels.

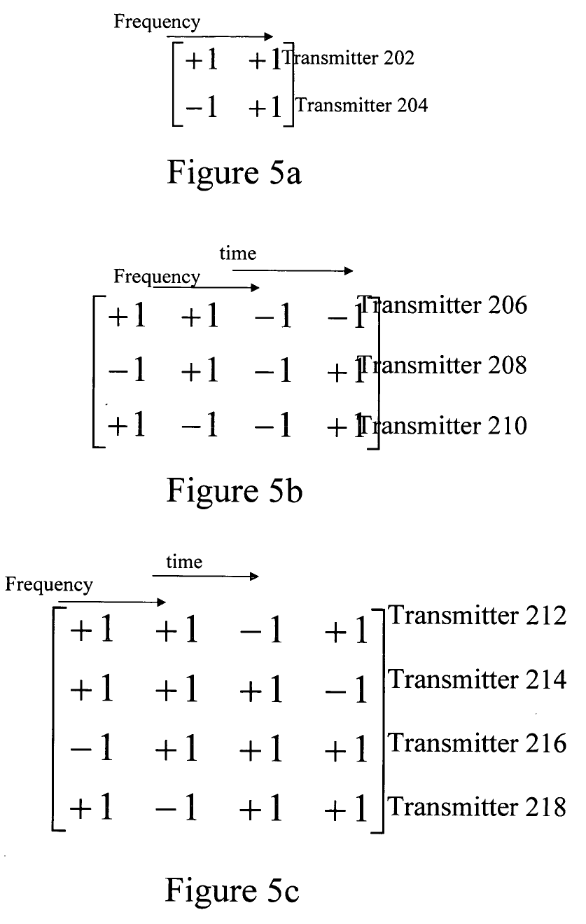

As shown below, the set of pilots for each transmitter may be rotated across pilot indices over time. FIGS. 5a-5c illustrates examples of matrices where the pilot sets are swapped to maintain robustness against variety of channels. To maintain robustness against a variety of channels, the pilot sets can be swapped every symbol for two transmitters or every pair of symbols for three-four transmitters.

FIG. 5a illustrates a matrix where the pilot sets, shown in FIG. 2a, are swapped every symbol for two transmitters to maintain robustness. As such, transmitter 202 transmits the values [+1+1] in a second symbol in one time period and transmitter 204 transmits the values [−1+1] in the second symbol in one time period.

FIG. 5b illustrates a matrix where the pilot sets, shown in FIG. 2b, are swapped every pair symbols for three transmitters to maintain robustness. Therefore, transmitter 206 transmits the values [+1+1] in a third symbol in a first time period and the values [−1−1] in a fourth symbol in a second time period. Similarly, transmitter 208 transmits the values [−1+1] in the third symbol in the first time period and the values [−1+1] in the fourth symbol in the second time period. Transmitter 210 transmits the values [+1−1] in the third symbol in the first time period and the values [−1+1] in the fourth symbol in a second time period.

FIG. 5c illustrates a matrix where the pilot sets, as shown in FIG. 2c, are swapped every pair symbols for four transmitters to maintain robustness. In FIG. 5c, transmitter 212 transmits the values [+1+1] in a third symbol in a first time period and the values [−1+1] in a fourth symbol in a second time period. Similarly, transmitter 214 transmits the values [+1+1] in the third symbol in the first time period and the values [+1−1] in the fourth symbol in the second time period. Transmitter 216 transmits the values [−1+1] in the third symbol in the first time period and the values [+1+1] in the fourth symbol in a second time period. Transmitter 218 transmits the values [+1−1] in the third symbol in the first time period and the values [+1+1] in the fourth symbol in a second time period.

Additionally, utilizing rotation for various pilots at various time instances, the transmitters can properly identify various pilots. To clarify the issue regarding pilot set or pilot symbol rotation, an important aspect is that for any number of transmitters and any number of pilots, the pilot sets are rotated across the pilot indices; therefore, the first pilot set can become the second pilot set, the second pilot set can become the third pilot set, etc. In the case that multiple time instances are needed to transmit all pilot sets, the pilot set rotation occurs after each group of time instances. For example, if two time instances are needed to transmit a pilot set, then the pilot sets are rotated every two time instances.

It should be noted that, in one example of the invention, for a given pilot number, the pilot sets can contain at most one weighting which has an opposite (i.e. negative) polarity of the others. This technique can be applied when the number of transmitters is large, for example, larger than four. The pilot set rotation can be considered to be a layer on top of this weighting method, and could also be applied when the number of transmitters is large, such as larger than four. The invention, therefore, enables pilot signals to be effectively utilized in multiple transmitter configurations, providing additional flexibility with respect to coherent detection of errors. The inventive method of transmitting pilot symbols over multiple transit paths enable receivers to use the pilot symbols, as mentioned previously, to track changes in the channel, frequency changes, and/or phase changes. Utilizing the same pilot signals on all transmit paths eliminates this additional flexibility. By using a structure or specified pilot set as discussed above, the invention allows for channel, frequency, and/or phase tracking of multiple transmit signals.

The disclosed structure and/or weighting, combined with rotation of the pilot sets over time, provide a traceable interrelationship of pilot signals, while enabling tracking on the multiple transmit paths. In addition to the weighting discussed above, the specified pilot sets can be scaled by a complex value. The specified pilot sets can also be reordering, and/or permuting across transmitters and across pilot indices. Additionally, the specified pilot sets can be scaled by a complex value which varies and/or repeats over time. Moreover, the pilots within a pilot set can each be scaled by possible different complex values and the scaling can vary over time. It should be noted that the present invention provides for the use of any subset of the pilot sets illustrated in FIGS. 2-5. For example, referring to FIG. 4d which deals with 8 pilots and 4 transmitters, if 6 pilots are to be used for 3 transmitters, one can create a pilot set matrix using rows marked 414,416,418 and the first, second, fourth, fifth, seventh, and eighth columns of the matrix, wherein the resulting 3×6 matrix would be:

$$[ \begin{matrix}+ 1 + 1 - 1 - 1 - 1 - 1 \\ + 1 + 1 + 1 - 1 + 1 + 1 \\ + 1 - 1 + 1 - 1 - 1 + 1\end{matrix} ]$$

It should be appreciated by one skilled in art, that although examples of the present invention are described with respect to IEEE™ 802.11a and 802.11g, the inventive method may be utilized in any device that implements the OFDM encoding scheme. The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed:

1. A network device for transmitting a set of known pilot symbols in a communications system, the network device comprising:
generating means for generating the set of known pilot symbols to be transmitted for each of a plurality of transmit sources;
inserting means for inserting pilot symbols into sub-carriers for each of the plurality of transmit sources; and
creating means for creating a near to full orthogonal matrix over time and frequency;
wherein a receiving station utilizes the pilot symbols for at least one of channel, frequency, and phase tracking.

2. The network device according to claim 1, wherein the inserting means inserts weighted pilot symbols for each of the plurality of transmit sources.

3. The network device according to claim 2, wherein when the plurality of transmit sources comprises two transmit sources and two known pilot symbols are sent per transmit source, where n is equal to an integer, for symbols 2n-1, the plurality of transmit sources send a value in vector p₁ on pilot set 1, and in vector p₂ on pilot set 2; and for symbols 2n the plurality of transmit sources send a value in vector p₂ on pilot set 1, and in vector p₁ on pilot set 2,
wherein p₁ is equal to +1, +1 and p₂ is equal to +1, −1.

4. The network device according to claim 2, wherein when the plurality of transmit sources comprises three transmit sources and two known pilot symbols are sent per transmit source, where n is equal to an integer, for symbols 2n-1, the plurality of transmit sources send a value in vector p₁ on pilot 1, if n is even; in vector p₂ on pilot 1, if n is odd, in vector p₂ on pilot 2 if n is odd and in vector p₁ on pilot 2 if n is even; and for symbols 2n the plurality of transmit sources send a value in vector p₃ on pilot 1, if n is odd, in vector p₄ on pilot 1 if n is even, in pilot p₄ on pilot 2 if n is odd and in vector p₃ on pilot 2 if n is even,
wherein p₁ is equal to +1, +1, −1, p₂ is equal to +1, −1, +1, p₃ is equal to −1, +1, +1 and p₄ is equal to −1, −1, −1.

5. The network device according to claim 2, wherein when the plurality of transmit sources comprises four transmit sources and two known pilot symbols are sent per transmit source, where n is equal to an integer, for symbols 2n-1, the plurality of transmit sources send a value in vector p₁ on pilot 1, if n is odd; in vector p₂ on pilot 1, if n is even, in vector p₂ on pilot 2 if n is odd and in vector p₁ on pilot 2 if n is even; and for symbols 2n the plurality of transmit sources send a value in vector p₃ on pilot 1 if n is odd, in vector p₄ on pilot 1 if n is even, in pilot p₄ on pilot 2 if n is odd and in vector p₃ on pilot 2 if n is even,
wherein p₁ is equal to +1, +1, +1, −1, p₂ is equal to +1, +1, −1, +1, p₃ is equal to +1, −1, +1, +1 and p₄ is equal to −1, +1, +1+1.

6. The network device according to claim 1, wherein the generating means is configured to generate four known pilot symbols to be transmitted for each of a plurality of transmit sources, wherein the four known pilot symbols are transmitted in one time period.

7. The network device according to claim 1, wherein polarities of the known pilot symbols is inverted for varying transmitters to properly identify a source for each of the know pilot symbols.

8. The network device according to claim 1, further comprising sending means for sending the pilots in subsets over time when there are fewer pilots than transmitters.

9. The network device according to claim 1, wherein the network device is configured to use any subset of generated pilots sets.

10. The network device according to claim 2, wherein a set of eight pilot symbols are transmitted for each of the plurality of transmit sources, wherein pilot sets are cycled over symbols for robustness across various channels.

11. The network device according to claim 1, wherein the set of pilot symbols for each of the plurality of transmit sources is rotated across a pilot index over a period of time.

12. The network device according to claim 1, wherein the set of pilot symbols is swapped every symbol when the plurality of transmit sources is equal to two to maintain robustness to channels.

13. The network device according to claim 1, wherein the set of pilot symbols is swapped every pair of symbols when the plurality of transmit sources is equal to three or four to maintain robustness to channels.

14. The network device according to claim 1, wherein for a given pilot number, pilot sets can contain at most one weighting which has an opposite polarity to the other pilot sets.

15. The network device according to claim 1, wherein the inserting means inserts scaled pilot symbols for each of the plurality of transmit sources.

16. The network device according to claim 1, wherein the inserting means performs at least one of reordering or permutation of pilot symbols across the plurality of transmit sources and across pilot indices.

17. The network device according to claim 1, wherein the inserting means inserts scaled pilot symbols for each of the plurality of transmit sources, wherein the pilot symbols for each pilot set is scaled by a complex value which varies over time.

18. The network device according to claim 1, wherein the inserting means inserts scaled pilot symbols for each of the plurality of transmit sources, wherein the pilot symbols within each pilot set is scaled by different complex values which varies over time.

19. A method for transmitting a set of known pilot symbols in a communications system, the method comprising the steps of:
generating the set of known pilot symbols to be transmitted for each of a plurality of transmit sources;
inserting pilot symbols into sub-carriers for each of the plurality of transmit sources;
creating a near to full orthogonal matrix over time and frequency using a minimum number of pilot symbols; and
using the pilot symbols for at least one of channel, frequency, and phase tracking at a receiving station.

20. The method according to claim 19, wherein the step of inserting comprises inserting weighted pilot symbols for each of the plurality of transmit sources.

21. The method according to claim 19, wherein the step of inserting comprises inserting scaled pilot symbols for each of the plurality of transmit sources.

22. The method according to claim 19, wherein the step of inserting comprises performing at least one of reordering or permutation of pilot symbols across the plurality of transmit sources and across pilot indices.

23. The method according to claim 19, wherein the step of inserting comprises inserting scaled pilot symbols for each of the plurality of transmit sources, wherein the pilot symbols for each pilot set is scaled by a complex value which varies over time.
